(19) United States
(12) Patent Application Publication
(10) Pub. No.: US 2005/0158139 A1
(43) Pub. Date: Jul. 21, 2005

(54) Fixing plug

(76) Inventors: Paul Steabben Hepworth, Guildford (GB); Simon James Skillings, Staffordshire (GB)

Correspondence Address: NIKOLAI & MERSEREAU, P.A., 900 SECOND AVENUE SOUTH, SUITE 820, MINNEAPOLIS, MN, 55402, US

(21) Appl. No.: 11/053,168

(22) Filed: Feb. 8, 2005

(30) Foreign Application Priority Data
Aug. 8, 2002 (GB) 0218514.8

(51) Int. Cl. F16B 13/06

(52) U.S. Cl. 411/55

(57) ABSTRACT

A fixing plug for anchoring a fixing to a support, including a unitary elongate body having an inner axial end and an outer axial end, a first longitudinal portion extending inwardly from said outer axial end, a third longitudinal portion extending outwardly from said inner axial end and a second longitudinal portion extending between said first and third longitudinal portions. The third longitudinal portion has at least one longitudinally extending slot, dividing the third longitudinal portion into a pair of longitudinally extending arms. An axially extending bore located internally of the first and second longitudinal portions, the bore having an outer axial end at said outer axial end of the body and an inner axial end located adjacent to the slot formed in the third longitudinal portion. The bore has a portion located within the second longitudinal portion, having a smaller diameter than the remainder of the bore.

The present invention relates to a fixing plug by which a fixing, such as a bolt or screw, can be securely fastened to a support such as a wall.

Fixing plugs are well known and usually are injection moulded from a suitable plastics material. They are commonly of two types, viz. (i) fixing plug suitable for securance to a solid wall (i.e. a wall having a depth greater than the length of the plug such that the entire length of the plug is located within a bore formed in the solid wall), and (ii) a fixing plug suitable for securance to a thin wall sheet of the kind used for creating a cavity wall (i.e. the wall sheet has a thickness less than the length of the wall sheet such that an end potion of the fixing plug projects beyond the inner surface of the wall sheet).

A general aim of the present invention is to provide a fixing plug which is suitable for use as a solid wall and a wall sheet fixing plug.

Various aspects of the present invention are hereinafter described with reference to the accompanying drawings, in which:

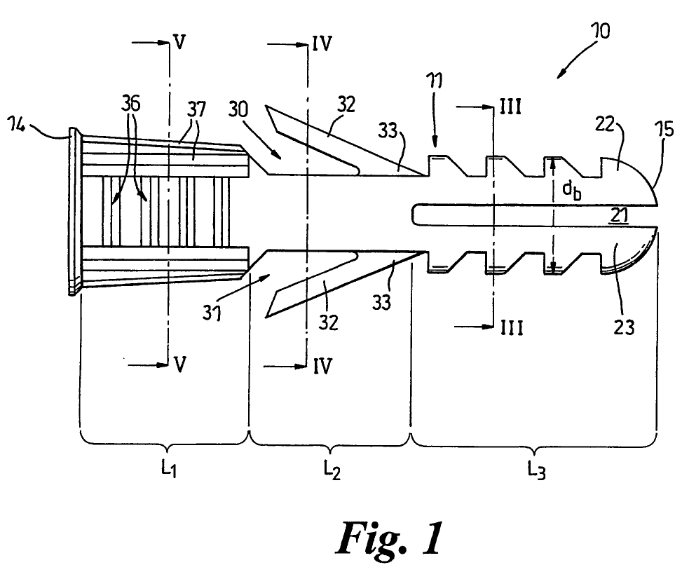

FIG. 1 is a side view of an embodiment of the present invention;

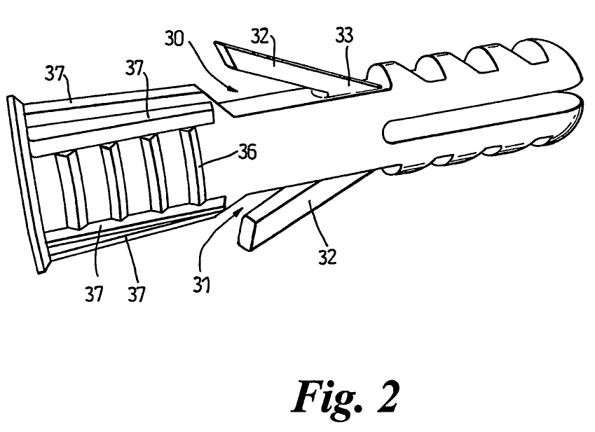

FIG. 2 is a perspective view of the fixing plug shown in FIG. 1;

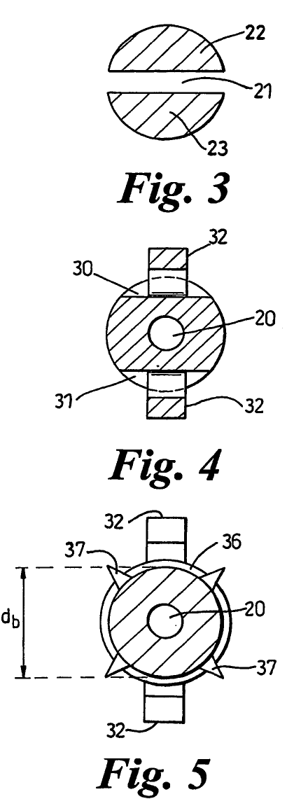

FIG. 3 is a sectional view along line III-III in FIG. 1;

FIG. 4 is a sectional view along line IV-IV in FIG. 1;

FIG. 5 is a sectional view along line V-V in FIG. 1;

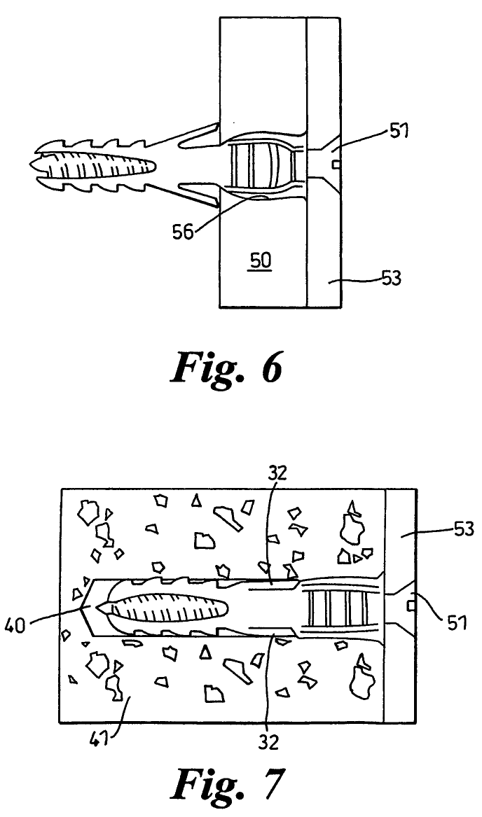

FIG. 6 is a schematic side view of the fixing plug of FIG. 1 shown in situ in a wall sheet; and

FIG. 7 is a schematic side view of the fixing plug of FIG. 1 shown in situ in a solid wall.

The fixing plug 10 shown in the accompanying drawings includes an elongate body 11 which is preferably moulded in one piece by injection moulding from a suitable plastics material such as polypropylene.

The body 11 includes a first longitudinal portion L₁ extending inwardly from its outer end 14, a third portion L₃ extending outwardly from its inner end 15 and a second portion L₂ located between the first and third longitudinal portions L₁,L₃.

The body 11 is generally of cylindrical form; it has a circular cross-section of constant outer diameter d_{b} along its length. The body 11 includes a centrally located bore 20 which extends through both the first and second longitudinal portions L₁,L₂. Preferably the diameter of the bore 20 where it extends through the second longitudinal portion L₂ is less than the diameter of bore 20 where it extends through the first longitudinal portion L₁.

The body 11 also includes at least one longitudinally extending slot 21 which extends through the third longitudinal portion L₃, thereby dividing L₃ into diametrically opposed arms 22,23.

The length of slot 21 is preferably the same as the length of the third longitudinal portion L₃, but in some embodiments may be greater than the length of the third longitudinal portion L₃ such that it extends partially into the second longitudinal portion L₂.

The slot 21 communicates with the bore 20 so that a screw fixing emerging from the bore 20 enters centrally along the slot 21.

Along the length of the second longitudinal portion L₂ there are provided two diametrically opposed longitudinal recesses 30,31. Each recess 30,31 is of a constant depth dᵣ along its length. Associated with each recess 30,31 there is an inclined arm 32 having a root 33 connected to the inner end of its associated recess 30 or 31; the arm 32 projects laterally away from the body 11 as it extends to the outer end 14 of the body 11.

Each arm 32 preferably has a thickness along its length which is the same or less than the depth dᵣ of its associated recess 30 or 31. Accordingly each arm 32 is able to be deflected towards the body 11 and be accommodated within its associated recess 30 or 31 so as not to project beyond diameter d_{b}.

In other embodiments however, each arm 32 may have a thickness along its length which is greater than the depth dᵣ of its associated recess 30 or 31.

Thus as shown in FIG. 7, the fixing plug 10 may be inserted along a bore 40 (of the same or slightly larger diameter than d_{b}) formed in a solid wall 41 and in so doing, the arms 32 are deflected inwardly and accommodated in their associated recess 30 or 31.

The first longitudinal portion L₁ preferably has a plurality of discrete projections 80 projecting from its outer peripheral surface. Preferably as shown projections 80 are in the form of a series of axially spaced circumferentially extending ribs 36 and a series of circumferentially spaced longitudinally extending ribs 37. Both series of ribs 36, 37 project beyond diameter d_{b} for engagement with the wall of bore 40.

FIG. 6 illustrates the use of the plug 10 with a wall sheet 50 in which a screw fixing 51 is used to attach an item 53 to the wall sheet 50. The plug 10 is located within a bore 56 extending through the wall sheet 50, the bore 56 having a diameter the same as or slightly larger than diameter d_{b}.

The first longitudinal portion L₁ is of an axial length slightly longer than the thickness of the wall sheet 50. Accordingly when the plug 10 is initially inserted into bore 56, the arms 32 are deflected inwardly into their associated recess 30 or 31 and then deflect outwardly when clear of the inner surface of the wall sheet 50. In this position, the arms 32 define barbs to prevent axial withdrawal of the plug 10 even without the insertion of the screw fixing 51 and so provides a safety feature by preventing axial withdrawal of the plug 10. The arms 32 are able to provide a high resistance to axial withdrawal of the plug 10 since they are relatively short in length and since the roots 33 of each arm 32 is prevented from moving radially inwardly of the plug 10 due to the solid nature of the second longitudinal portion L₂ to which the roots 33 are attached.

The longitudinally extending ribs 37 bite into the surrounding wall of bore 56 and act to prevent rotation of the plug 10 as the screw 51 is inserted and rotated.

The diameter of the bore 20 in the first longitudinal portion L₁ is chosen to be smaller than the diameter of the screw 51.

The effect of this is to create outward expansion of the first longitudinal portion L₁ in order to cause the series of ribs 36 to be pressed firmly against the surrounding wall of bore 40. It is the interaction between the outwardly expanded first longitudinal portion L₁ and the surrounding wall of bore 20 which is primarily responsible for preventing axial withdrawal of the plug 10 from the bore 20 when in use.

It will be appreciated that ribs 36 assist in the interaction of the first longitudinal portion L₁ with the surrounding wall of bore 20 and that the number of ribs 36 provided may be varied i.e. there may be more or less than 4 circumferentially extending ribs 36.

It will also be appreciated that ribs 36 provide little resistance to rotation of the plug 10 when a screw 51 is first inserted and that ribs 37 provide less resistance to axial withdrawal of the plug 10 than ribs 36. Thus the two series of ribs 36, 37 primarily provide two discrete functions; one series provides resistance to rotation of the plug; the other series provides resistance to axial withdrawal of the plug.

Whilst this is the preferred arrangement, it will be appreciated that individual projections 80 of a different shape may be adopted which provide both functions of preventing rotation and axial withdrawal of the plug 10. For example, a series of pinnacle-like projections may be provided spaced both circumferentially and axially along the first longitudinal portion L₁.

It is preferred that the bore 20 in the second longitudinal portion L₂ has a diameter less than that of the first longitudinal portion L₁ in order to provide a greater degree of bite for the screw 51; it is the primary function of the second longitudinal portion L₂ to provide sufficient bite between the plug 10 and screw 51 to prevent axial withdrawal, by a pulling action, of the screw 51 from the plug 10.

When the screw 51 is fully inserted as seen in FIG. 6, it is located between the arms 22, 23 and causes these to splay apart. Since arms 22, 23 are in the free space, they do not act to restrain axial withdrawal of the plug 10.

FIG. 7 illustrates the use of the plug 10 in a solid wall 40 wherein the plug 10 is inserted into a bore 41.

As with use in a wale sheet 50, axial withdrawal of the plug 10 from a solid wall 40 is prevented by interaction between the first longitudinal portion L₁ and the surrounding wall of bore 41.

In addition, axial withdrawal of the plug 10 is also prevented by the interaction of arms 22, 23 with the surrounding wall of bore 41. In this respect, arms 22, 23 are caused to move radially outwardly due to screw 51 projecting along slot 21 to be pressed against the surrounding wall of bore 41.

1. A fixing plug for location in a bore in a support such as a wall for anchoring a screw fixing to the support, the plug comprising, a unitary elongate body formed from a plastics material, the body having an inner axial end and an outer axial end and further having a first longitudinal portion extending inwardly from said outer axial end, a third longitudinal portion extending outwardly from said inner axial end and a second longitudinal portion extending between said first and third longitudinal portions, the third longitudinal portion having at least one longitudinally extending slot which divides the third longitudinal portion into a pair of longitudinally extending arms, an axially extending screw accommodating bore located internally of the first and second longitudinal portions, the screw accommodating bore having a diameter in said first and second longitudinal portions which is less than the diameter of the screw fixing, an outer axial cnd located at said outer axial end of the body and an inner axial end located adjacent to the slot formed in the third longitudinal portion, the bore having a portion located within the second longitudinal portion which is of a smaller diameter than the remainder of the bore.

2. A fixing plug according to claim 1 wherein the fixing plug is intended for securing the screw fixing to a wall sheet of given thickness, said first longitudinal portion being of a length slightly greater than said given thickness.

3. A fixing plug according to claim 2 wherein said second longitudinal portion includes two diametrically opposed longitudinal recesses and an inclined arm assobiated with each recess, each aim being deflectable to be accommodated in its associated recess during insertion of the plug into the bore formed in said support.

4. A fixing plug according to claim 1, wherein the first longitudinal portion is provided with projections which inter-engage with the bore in said support to provide resistance to rotation and axial withdrawal of the plug when accommodated in the bore in said support.

5. A fixing plug according to claim 2, wherein the first longitudinal portion is provided with projections which inter-engage with the bore in said support to provide resistance to rotation and axial withdrawal of the plug when accommodated in the bore in said support.

6. A fixing plug according to claim 3, wherein the first longitudinal portion is provided with projections which inter-engage with the bore in said support to provide resistance to rotation and axial withdrawal of the plug when accommodated in the bore in said support.

7. A fixing according to claim 4 wherein said projections are in the form of a series of circumferentially extending ribs spaced longitudinally along the first longitudinal portion and a series of longitudinally extending ribs which are circumferentially spaced about the first longitudinal portion.

8. A fixing according to claim 5 wherein said projections are in the form of a series of circumferentially extending ribs spaced longitudinally along the first longitudinal portion and a series of longitudinally extending ribs which are circumferentially spaced about the first longitudinal portion.

9. A fixing according to claim 6 wherein said projections are in the form of a series of circumferentially extending ribs spaced longitudinally along the first longitudinal portion and a series of longitudinally extending ribs which are circumferentially spaced about the first longitudinal portion.
